(19) United States
(12) Patent Application Publication
(10) Pub. No.: US 2024/0232625 A1
(43) Pub. Date: Jul. 11, 2024

(54) TRAINING DEVICE, TRAINING METHOD, AND TRAINING PROGRAM

(71) Applicant: NIPPON TELEGRAPH AND TELEPHONE CORPORATION, Tokyo (JP)

(72) Inventors: Sekitoshi KANAI, Musashino-shi, Tokyo (JP); Yasutoshi IDA, Musashino-shi, Tokyo (JP)

(73) Assignee: NIPPON TELEGRAPH AND TELEPHONE CORPORATION, Tokyo (JP)

(21) Appl. No.: 18/563,397

(22) PCT Filed: May 26, 2021
(86) PCT No.: PCT/JP2021/019982

§ 371 Date: Nov. 22, 2023

(51) Int. Cl. G06N 3/08

(52) U.S. Cl. CPC G06N 3/08

(57) ABSTRACT

A learning device calculates an objective function when data created as an adversarial attack is input to a deep learning model by Entropy-SGD. The learning device updates parameters of the deep learning model so that an objective function is optimized.

### TECHNICAL FIELD

The present invention relates to a learning device, a learning method, and a learning program.

### BACKGROUND ART

Conventionally, deep learning and deep neural networks have achieved great success in image recognition, voice recognition, and the like. For example, in image recognition using deep learning, when an image is inputted to a model including many nonlinear functions of deep learning, an identification result of what the image shows is outputted. In particular, convolutional networks and ReLUs are commonly used in image recognition. In the following description, a deep neural network trained by deep learning may be simply referred to as a deep learning model or a model.

On the other hand, if a malicious attacker adds noise to the input image, the deep learning model can be easily misidentified with small noise (Reference Document: Christian Szegedy, et al. “Intriguing properties of neural networks.” arXiv preprint: 1312.6199, 2013). Such attacks are called adversarial attacks.

As a method for making deep learning robust against adversarial attacks, adversarial learning to be added as data when adversarial attacks are learned in advance has been proposed (See, for example, Non Patent Literatures 1 and 2).

Since an objective function (loss function) optimized in adversarial learning is not smooth, a learning method using a normal gradient may not be efficient (see, for example, Non Patent Literature 3).

As a method for improving the smoothness of the objective function in deep learning, Entropy-SGD using SGLD (Reference Document: M. Welling and Y. W. Teh. “Bayesian learning via stochastic gradient Langevin dynamics.” In ICML, 2011) internally has been proposed (see, for example, Non Patent Literature 4).

### CITATION LIST

### Non Patent Literature

Non Patent Literature 1: Goodfellow, Ian J., Jonathon Shlens, and Christian Szegedy. “Explaining and harnessing adversarial examples.” arXiv preprint:1412.6572 2014.
Non Patent Literature 2: Madry Aleksander, et al. “Towards deep learning models resistant to adversarial attacks.” arXivpreprint:1706.06083, 2017.
Non Patent Literature 3: Liu, Chen, et al. “On the Loss Landscape of Adversarial Training: Identifying Challenges and How to Overcome Them.” Advances in Neural Information Processing Systems 33 (2020).
Non Patent Literature 4: Chaudhari, Pratik, et al. “Entropy-SGD: Biasing Gradient Descent into Wide Valleys.” arXivpreprint:1611.01838 (2016).

### SUMMARY OF INVENTION

### Technical Problem

However, conventional technologies have a problem that learning efficiency cannot be improved while an objective function of adversarial learning is smoothed.

For example, there is a problem that noise disclosed in Non Patent Literature is not robust in some cases. For example, Entropy-SGD disclosed in Non Patent Literature 4 smooths an objective function, but learning efficiency may not be sufficiently high.

### Solution to Problem

In order to solve the above-described problems and achieve the object, a learning device includes: a calculation unit that calculates by Entropy-SGD an objective function when data created as an adversarial attack is input to a deep learning model; and an update unit that updates parameters of the deep learning model so that the objective function is optimized.

### Advantageous Effects of Invention

According to the present invention, the deep learning model can be made robust against noise.

### BRIEF DESCRIPTION OF DRAWINGS

FIG. 1 is a diagram illustrating a structure of an entire deep learning model.

FIG. 2 is a diagram illustrating a configuration example of a learning device according to a first embodiment.

FIG. 3 is a diagram for explaining an Entropy-SGD algorithm.

FIG. 4 is a diagram for explaining an algorithm of an embodiment.

FIG. 5 is a diagram for explaining an algorithm of an embodiment.

FIG. 6 is a flowchart illustrating a flow of deep learning.

FIG. 7 is a flowchart illustrating a flow of learning using Entropy-SGD.

FIG. 8 is a flowchart illustrating a flow of update processing in learning.

FIG. 9 is a flowchart illustrating a flow of update processing according to an embodiment.

FIG. 10 is a flowchart illustrating a flow of update processing according to an embodiment.

FIG. 11 is a flowchart illustrating a flow of update processing in adversarial learning.

FIG. 12 is a flowchart illustrating a flow of update processing in adversarial learning according to an embodiment.

FIG. 13 is a flowchart illustrating a flow of update processing in adversarial learning according to an embodiment.

FIG. 14 is a diagram illustrating an example of a computer that executes a program.

### DESCRIPTION OF EMBODIMENTS

### (Deep Learning)

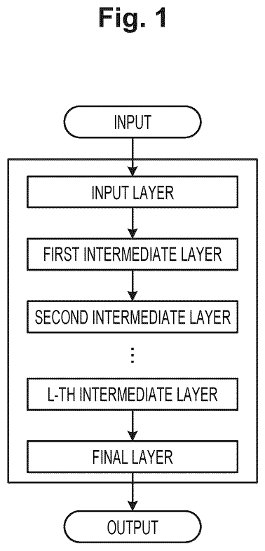

First, a deep learning model will be described with reference to FIG. 1. FIG. 1 is a diagram illustrating a structure of an entire deep learning model. In the following description, it is assumed that deep learning is performed by a learning device 10a.

As illustrated in FIG. 1, the deep learning model includes an input layer into which a signal is input, one or more intermediate layers that convert a signal from the input layer, and a final layer that converts a signal from the intermediate layer into an output such as probability.

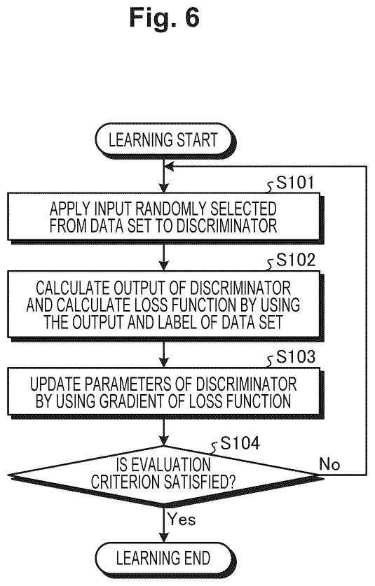

FIG. 6 is a flowchart illustrating a flow of deep learning. As illustrated in FIG. 6, first, the learning device 10a applies an input randomly selected from a data set prepared in advance to a discriminator (step S101).

Next, the learning device 10a calculates an output of the discriminator and calculates a loss function using the output and a label of the data set (step S102). Then, the learning device 10a updates the parameter of the discriminator using the gradient of the loss function (step S103). The loss function is an example of the objective function.

In a case where an evaluation criterion is not satisfied (step S104, No), the learning device 10a returns to step S101 and repeats the processing. On the other hand, in a case where the evaluation criterion is satisfied (step S104, Yes), the learning device 10a terminates the processing.

For example, the learning device 10a updates the parameter so that the loss function becomes small. Since a function that becomes smaller as the output of the discriminator and the label match is usually set as the loss function, the discriminator can identify the label of the input by the learning processing.

The evaluation criterion in step S104 is, for example, whether a separately prepared data set can be correctly identified.

Hereinafter, in the expressions in the drawings, formulas, and the like, bold letters in capital letters represent a matrix, and bold letters in small letters represent a column vector. The column vector is expressed using transposition.

Although image recognition by deep learning will be described as an example here, the embodiment can be applied to various identification tasks other than image recognition.

As image recognition by deep learning, a problem of recognizing an image x∈R^{C×H×W} and obtaining a label y of the image from M labels is considered. However, C is a channel of the image (three channels in the case of the RGB format), H is a vertical size, and W is a horizontal size.

At this time, the deep learning model repeats a nonlinear function and a linear operation to output an output through a function called a softmax function in the final layer. z_{θ}(x)=[z_{θ,1}(x), z_{θ,2}(x), . . . , z_{θ,M}(x)] r is set as the vector obtained by conversion by the model and finally input to softmax.

Here, θ∈R^{d} is a parameter vector of a deep learning model, and z_{θ}(x) is called logit. Assuming that the softmax function is fₛ(·), the output of the model is an output fₛ(z_{θ}(x))∈R^{M} of the softmax, and the k-th output is expressed as in Formula (1).

$$[ Math . 1 ]$$

$${[ {f}_{s} ( {z}_{θ} ( x ) ) ]}_{k} = \frac{exp ( {z}_{θ , k} ( x ) )}{{\sum }_{m = 1}^{M} exp ( {z}_{θ , m} ( x ) )} \qquad ( 1 )$$

(1) The output of the Formula represents a score for each label in classification, and the element of the output with the largest score of i obtained by the Formula (2) is the recognition result of deep learning.

$$[ Math . 2 ]$$

$$i = {{argmax}_{k} [ {f}_{s} ( {z}_{θ} ( x ) ) ]}_{k} \qquad ( 2 )$$

Image recognition is one of classification, and a model fₛ(z_{θ}(·)) for performing classification is referred to as a discriminator. The parameter θ is learned using, for example, N data sets {(xᵢ, yᵢ)}, i=1, . . . , N prepared in advance. In this learning, a loss function l(x, y, θ) is set such that a value is small enough to correctly recognize yᵢ=argmaxₖ [fₛ(z_{θ}(x))]ₖ such as the cross entropy, and optimization is performed on the average of the data as in Formula (3) to obtain θ.

$$[ Math . 3 ]$$

$$θ = {argmin}_{θ} L ( θ ) = {argmin}_{θ} {\sum }_{i = 1}^{N} l ( {x}_{i} , {y}_{i} , θ ) \qquad ( 3 )$$

Learning is performed by optimization based on the gradient of the loss function, and θ is obtained by repeatedly performing the calculation of Formula (4).

$$[ Math . 4 ]$$

$${θ}_{τ} = {θ}_{τ - 1} - η {∇}_{θ} L ( {θ}_{τ - 1} ) \qquad ( 4 )$$

Here, η is a parameter called a learning rate. As a method for performing optimization more efficiently in optimization using a gradient, there is a method called Newton's method, and optimization of Formula (5) is performed.

$$[ Math . 5 ]$$

$${θ}_{τ} = {θ}_{τ - 1} - η {H}^{- 1} {∇}_{θ} L ( {θ}_{τ - 1} ) \qquad ( 5 )$$

where H is the Hessian matrix H=∇_{θ}²L(θ).

In adversarial learning for making the model robust, θ is obtained by optimization of Formula (6).

$$[ Math . 6 ]$$

$$θ = {argmin}_{θ} {\sum }_{i = 1}^{N} {max}_{{x}_{i}^{′} ∈ {B}_{ε} ( {x}_{i} )} l ( {x}_{i} , {y}_{i} , θ ) \qquad ( 6 )$$

Here, B(xᵢ) is a region of a distance E centered on xᵢ, and x′ᵢ obtained by maximizing is called an adversarial attack.

### (Entropy-SGD)

Entropy-SGD is a method for improving smoothness in deep learning. For the original loss function L(x, y, θ), Entropy-SGD minimizes the loss function of Formula (7).

$$[ Math . 7 ]$$

$$- F ( θ ) = - log {\int }_{{θ}^{′}} exp ( - β L ( {θ}^{′} ) - β \frac{γ}{2} {‖ θ - {θ}^{′} ‖}_{2}^{2} ) d {θ}^{′} \qquad ( 7 )$$

Formula (7) is the local entropy of a probability density function p_{θ}(θ′) shown in Formula (8).

$$[ Math . 8 ]$$

$${p}_{θ} ( {θ}^{′} ) = \frac{1}{{e}^{F ( θ , γ )}} exp ( - L ( {θ}^{′} ) - \frac{γ}{2} {‖ θ - {θ}^{′} ‖}_{2}^{2} \qquad ( 8 )$$

The gradient of the loss function of Formula (7) is expressed by Formula (9).

$$[ Math . 9 ]$$

$$- ∇ F ( θ ) = γ ( θ - {𝔼}_{{p}_{θ} ( {θ}^{′} )} [ {θ}^{′} ] ) \qquad ( 9 )$$

Here, Ep_{θ(θ′)}[θ′] is an expected value of the probability density function p_{θ}(θ′).

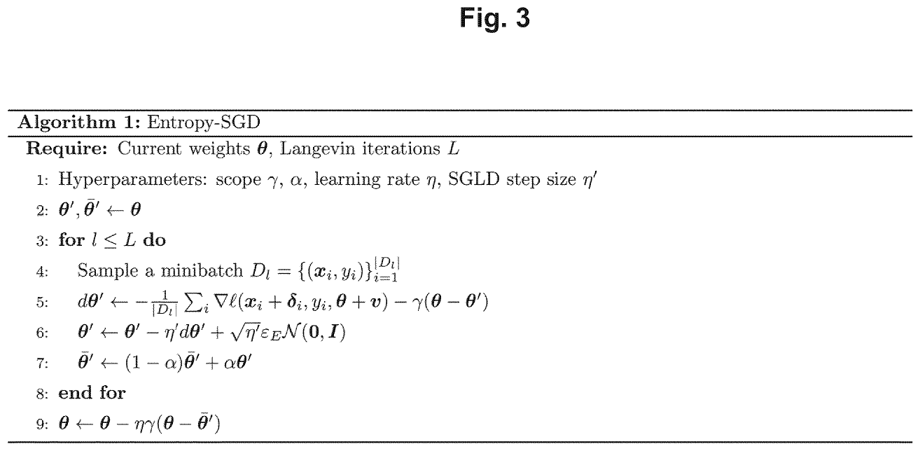

FIG. 3 illustrates an Entropy-SGD algorithm. FIG. 3 is a diagram for explaining the Entropy-SGD algorithm.

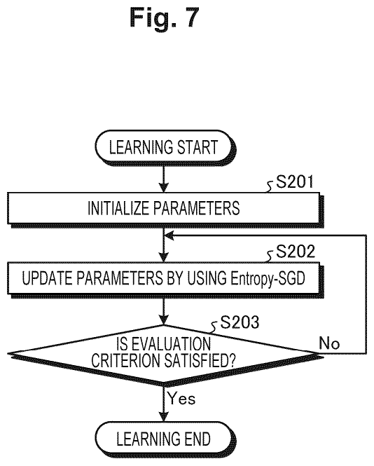

FIG. 7 is a flowchart illustrating a flow of learning using Entropy-SGD.

As illustrated in FIG. 7, first, the learning device 10a initializes parameters (step S201). Next, the learning device 10a updates the parameter using Entropy-SGD (step S202).

In a case where an evaluation criterion is not satisfied (step S203, No), the learning device 10a returns to step S202 and repeats the processing. On the other hand, in a case where the evaluation criterion is satisfied (step S203, Yes), the learning device 10a terminates the processing.

Here, in the third to eighth rows of FIG. 3, E_{pθ(θ′)}[θ′] is approximately obtained by a method called Stochastic Gradient Langevin Dynamics (SGLD).

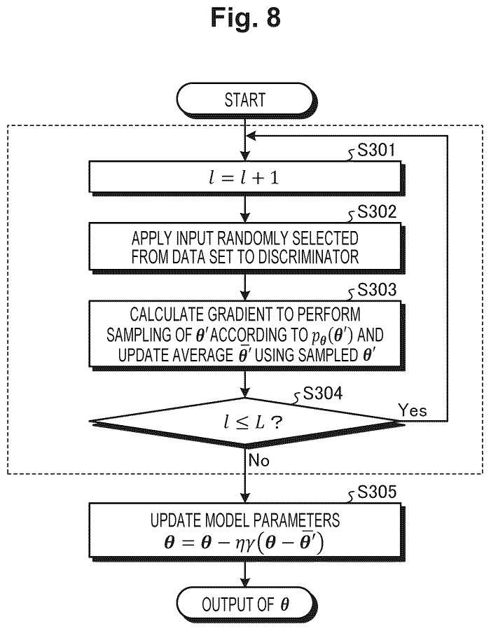

FIG. 8 is a flowchart illustrating a flow of update processing in learning. A portion surrounded by a broken line in FIG. 8 corresponds to the third to eighth rows in FIG. 3, that is, processing of calculating an expected value of θ′ by the SGLD.

As illustrated in FIG. 8, first, the learning device 10a increases l by 1 (step S301). Then, the learning device 10a applies an input randomly selected from the data set to the discriminator (step S302).

Here, the learning device 10a calculates the gradient to perform sampling of θ′ according to p_{θ(θ′)} and updates the average of θ′ using the sampled θ′ (step S303).

In a case where l is equal to or less than L (step S304, Yes), the learning device 10a returns to step S301 and repeats the processing. On the other hand, in a case where l is not equal to or less than L (step S304, No), the learning device 10a updates the model parameters (step S305).

### Learning Device of Embodiment

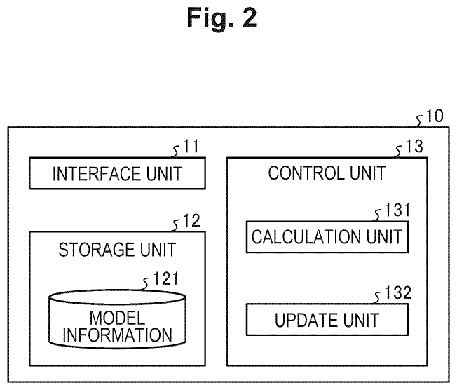

The configuration of the learning device according to the first embodiment will be described with reference to FIG. 2. FIG. 2 is a diagram illustrating a configuration example of the learning device according to the first embodiment. A learning device 10 accepts an input of a learning data set, learns a model, and outputs a learned model.

Units of the learning device 10 will be described. As illustrated in FIG. 2, the learning device 10 has an interface unit 11, a storage unit 12, and a control unit 13.

The interface unit 11 is an interface for inputting and outputting data. For example, the interface unit 11 includes a network interface card (NIC). Moreover, the interface unit 11 may include an input device such as a mouse or a keyboard, and an output device such as a display.

The storage unit 12 is a storage device such as a hard disk drive (HDD), a solid state drive (SSD), or an optical disc. Note that the storage unit 12 may be a data-rewritable semiconductor memory such as a random access memory (RAM), a flash memory, or a non-volatile static random access memory (NVSRAM). The storage unit 12 stores an operating system (OS) and various programs executed by the learning device 10. Moreover, the storage unit 12 stores model information 121.

The model information 121 is information such as parameters for constructing a deep learning model (discriminator). For example, the model information 121 includes the weight, bias, and the like of each layer of the deep neural network. Moreover, the deep learning model constructed by the model information 121 may be a learned model or an unlearned model.

The control unit 13 controls the entire learning device 10. The control unit 13 is, for example, an electronic circuit such as a central processing unit (CPU) or a micro processing unit (MPU), or an integrated circuit such as an application specific integrated circuit (ASIC) or a field programmable gate array (FPGA). Moreover, the control unit 13 includes an internal memory for storing programs and control data defining various processing procedures, and executes each of the types of processing by using the internal memory. Moreover, the control unit 13 functions as various processing units by operation of various programs. For example, the control unit 13 has a calculation unit 131, and an update unit 132.

Here, as described above, the loss function L(x, y, θ) of deep learning is a function that is not smooth when adversarial learning or the like is performed. In that case, optimization based on a gradient is not efficient.

Therefore, in order to improve the learning efficiency while smoothing the objective function of the adversarial learning, the learning device 10 has the following configuration. That is, the calculation unit 131 calculates an objective function when data created as an adversarial attack is input to the deep learning model by Entropy-SGD. In addition, the update unit 132 updates parameters of the deep learning model so that an objective function is optimized.

The learning device 10 can perform learning by the following Example 1 or Example 2 in which the efficiency of Example 1 is further improved.

### Example 1

The learning device 10 estimates the variance-covariance matrix by SGLD by using the fact that the Hessian matrix becomes the variance-covariance matrix in Entropy-SGD, and multiplies the variance-covariance matrix by an inverse matrix of the Hessian matrix as in the Newton method, thereby improving efficiency.

The learning device 10 calculates a Hessian matrix of Entropy-SGD. The (i, j) component of the Hessian matrix is expressed by Formula (10).

$$[ Math . 10 ]$$

$$\begin{matrix}\frac{{\partial }^{2} - F}{\partial {θ}_{j} \partial {θ}_{i}} = \frac{\partial }{\partial {θ}_{j}} γ ( {θ}_{i} - {𝔼}_{{p}_{θ}} [ {θ}_{i}^{′} ] ) \\ = γ ( {δ}_{ij} - γ ( {𝔼}_{{p}_{θ}} [ {θ}_{i}^{′} {θ}_{j}^{′} ] - {𝔼}_{{p}_{θ}} [ {θ}_{i}^{′} ] {𝔼}_{{p}_{θ}} [ {θ}_{j}^{′} ] ) )\end{matrix} \qquad ( 10 )$$

A matrix including the components of Formula (10) is Formula (11).

$$[ Math . 11 ]$$

$$- {∇}^{2} F = γ I - {γ}^{2} {\sum }_{{θ}^{′}} \qquad ( 11 )$$

Here, δ_{i,j} is a delta function that becomes 1 and others become 0 when i=j, and I is an identity matrix. Σ_{θ}·is a variance-covariance matrix of the probability density function p_{θ}(θ′).

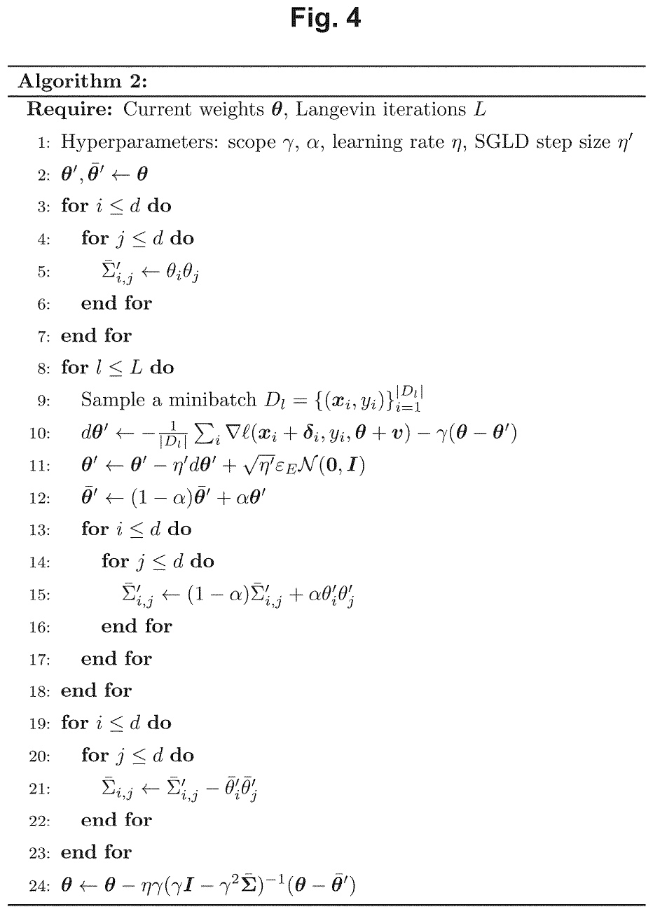

It is difficult to accurately obtain this variance-covariance matrix. Therefore, the learning device 10 approximates the variance-covariance matrix by the algorithm indicated by the pseudo code in FIG. 4 using the SGLD similarly to the expected value. FIG. 4 is a diagram for explaining an algorithm of an embodiment.

The learning device 10 performs approximate calculation of E_{pθ}[θi′θⱼ′] in the 13 to 17 rows of FIG. 4, performs approximate calculation of E_{pθ}[θᵢ′θⱼ′]-E_{pθ}[θᵢ′]E_{pθ}[θⱼ′] in the 19 to 22 rows, and calculates an inverse matrix of the Hessian matrix in the 24th row and multiplies the inverse matrix by a gradient. As a result, an increase in speed can be expected similarly to the Newton method.

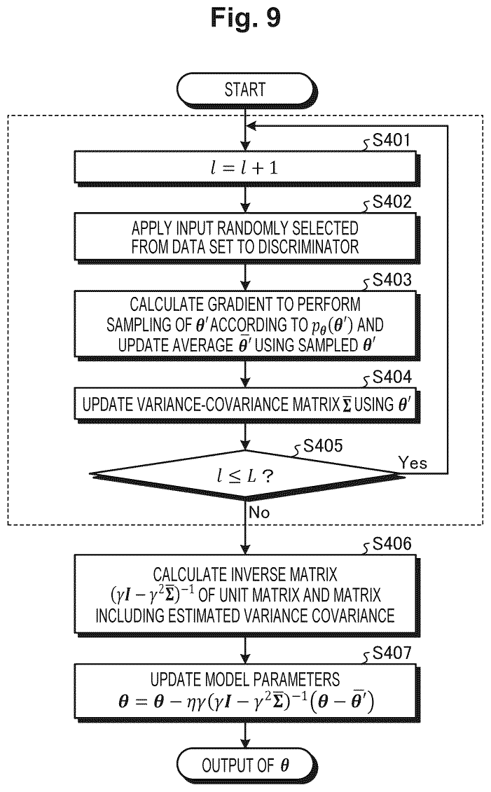

FIG. 9 illustrates a flow of the update processing in this case. FIG. 9 is a flowchart illustrating a flow of update processing according to an embodiment. The processing of FIG. 9 corresponds to the algorithm of FIG. 4.

As illustrated in FIG. 9, first, the learning device 10 increases l by 1 (step S401). Then, the learning device 10 applies an input randomly selected from the data set to the discriminator (step S402).

Here, the learning device 10 calculates the gradient to perform sampling of θ′ according to p_{θ(θ′)} and updates the average of θ′ using the sampled θ′ (step S403).

Further, the learning device 10 updates the variance-covariance matrix using θ′ (step S404).

In a case where l is equal to or less than L (step S405, Yes), the learning device 10 returns to step S401 and repeats the processing.

On the other hand, in a case where l is not equal to or less than L (step S405, No), the learning device 10 calculates an inverse matrix of a unit matrix and a matrix including the estimated (updated) variance covariance (step S406). Then, the learning device 10 updates the model parameters using the calculated inverse matrix (step S407).

In Example 1, the calculation unit 131 calculates a first matrix that is a variance-covariance matrix of parameters according to a probability distribution used in Entropy-SGD by stochastic gradient Langevin dynamics (SGLD). The update unit 132 updates the parameters of the deep learning model using the first matrix.

The update unit 132 updates the parameters of the deep learning model by multiplying the inverse matrix of the first matrix that is the Hessian matrix by the gradient.

### Example 2

Since it takes a calculation cost of O(d³) to calculate the inverse matrix, as a more efficient method, it is assumed that the covariance is 0, and that Σ is a diagonal matrix including a variance of each parameter. Then, the inverse matrix of the Hessian matrix is a diagonal matrix, and its (i, i) component is expressed by Formula (12).

$$[ Math . 12 ]$$

$${( - {∇}^{2} F )}_{i , j}^{- 1} = \frac{1}{γ - {γ}^{2} {σ}_{i , {θ}^{′}}} \qquad ( 12 )$$

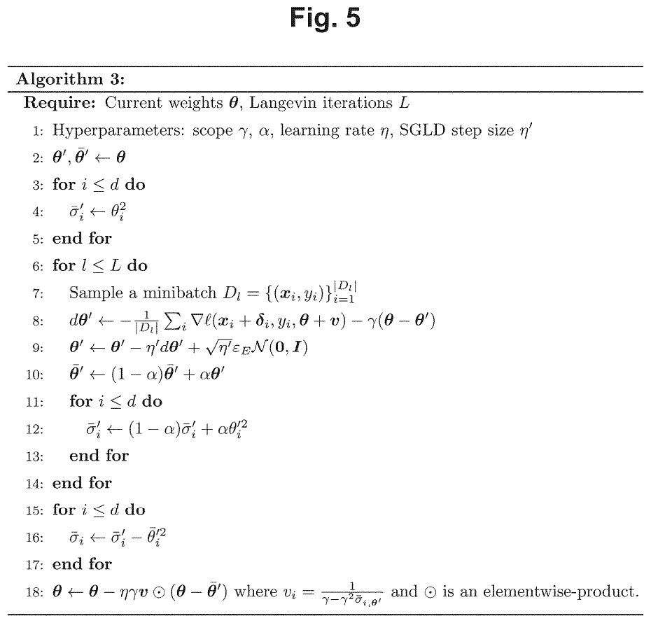

In this case, the learning device 10 only needs to multiply each parameter by the reciprocal of the variance. The learning device 10 approximates the variance-covariance matrix (variance matrix) having a covariance of 0 by the algorithm indicated by the pseudo code in FIG. 5. FIG. 5 is a diagram for explaining an algorithm of an embodiment.

The learning device 10 performs approximate calculation of E_{pθ}[θᵢ′θⱼ′] in the 11 to 13 rows of FIG. 5, performs approximate calculation of E_{pθ}[θᵢ′θⱼ′]-E_{pθ}[θᵢ′]E_{pθ}[θⱼ′] in the 15 to 17 rows, and calculates an inverse matrix of the Hessian matrix in the 18th row and multiplies the inverse matrix by a gradient.

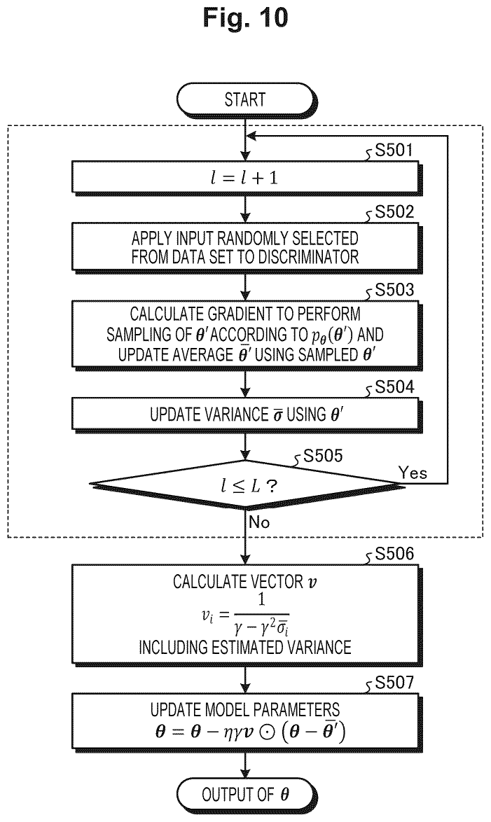

FIG. 10 illustrates a flow of the update processing in this case. FIG. 10 is a flowchart illustrating a flow of update processing according to an embodiment. The processing of FIG. 10 corresponds to the algorithm of FIG. 5.

As illustrated in FIG. 10, first, the learning device 10 increases l by 1 (step S501). Then, the learning device 10 applies an input randomly selected from the data set to the discriminator (step S502).

Here, the learning device 10 calculates the gradient to perform sampling of θ′ according to p_{θ(θ′)} and updates the average of θ′ using the sampled θ′ (step 3503).

Further, the learning device 10 updates the variance using θ′(step S504).

In a case where l is equal to or less than L (step S505, Yes), the learning device 10 returns to step S501 and repeats the processing.

On the other hand, in a case where l is not equal to or less than L (step 3505, No), the learning device 10 calculates a unit matrix and a vector including the estimated (updated) variance (step S506). Then, the learning device 10 updates the model parameters using the calculated vector (step S507).

In Example 2, the calculation unit 131 calculates a first matrix in which a covariance of a variance-covariance matrix calculated by stochastic gradient Langevin dynamics (SGLD) of parameters according to a probability distribution used in Entropy-SGD is assumed to be 0. The update unit 132 updates the parameters of the deep learning model using the first matrix.

The Entropy-SGD, Example 1, and Example 2 described above can be applied to adversarial learning. In particular, by applying the first embodiment and the second embodiment to the adversarial learning, an effect of improving the learning efficiency while smoothing the objective function of the adversarial learning is produced.

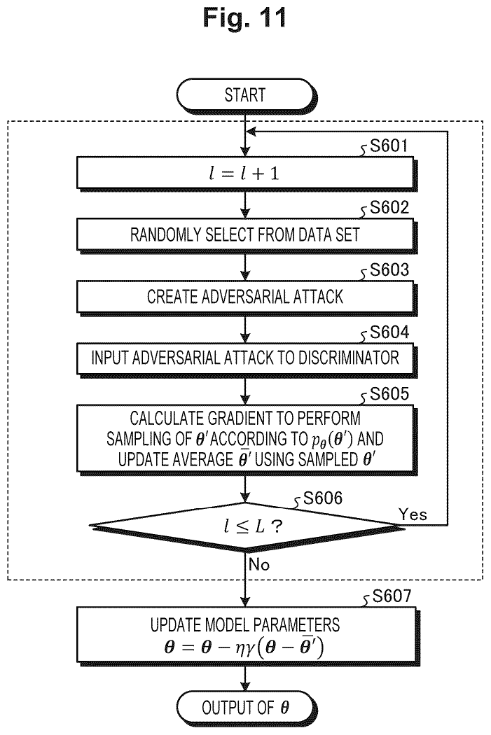

FIGS. 11, 12, and 13 illustrate processing in a case where Entropy-SGD, Example 1, and Example 2 are applied to adversarial learning, respectively. In these processes, an adversarial attack is created on the basis of an input randomly selected from a data set.

FIG. 11 is a flowchart illustrating a flow of update processing in adversarial learning. As illustrated in FIG. 11, first, the learning device 10a increases l by 1 (step S601). Then, the learning device 10a randomly selects an input from the data set (step S602).

Here, the learning device 10a creates an adversarial attack from the selected input (step S603). Then, the learning device 10a inputs (applies) the created adversarial attack to the discriminator (step S604).

Here, the learning device 10a calculates the gradient to perform sampling of θ′ according to p_{θ(θ′)} and updates the average of θ′ using the sampled θ′ (step S605).

In a case where l is equal to or less than L (step S606, Yes), the learning device 10a returns to step S601 and repeats the processing. On the other hand, in a case where l is not equal to or less than L (Step S606, No), the learning device 10a updates the model parameters (step S607).

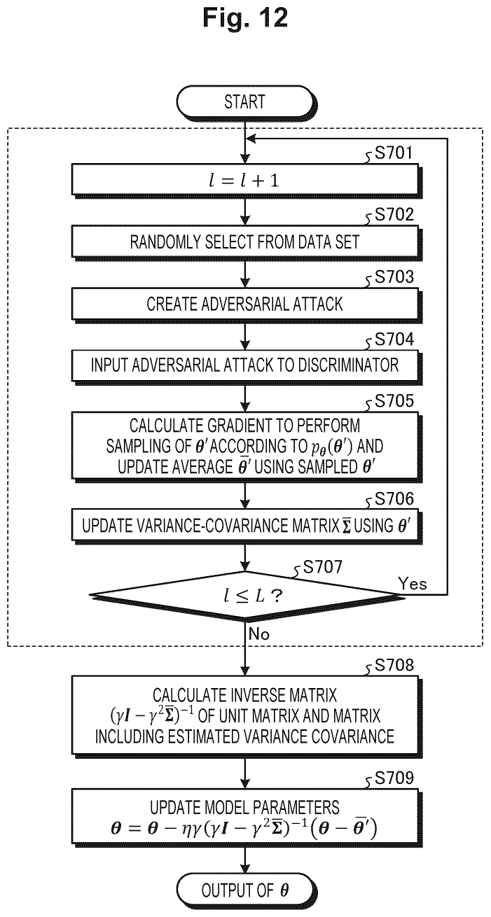

FIG. 12 is a flowchart illustrating a flow of update processing in adversarial learning according to an embodiment. As illustrated in FIG. 12, first, the learning device 10 increases l by 1 (step S701). Then, the learning device 10 randomly selects an input from the data set (step S702).

Here, the learning device 10 creates an adversarial attack from the selected input (step S703). Then, the learning device 10 inputs (applies) the created adversarial attack to the discriminator (step S704).

Here, the learning device 10 calculates the gradient to perform sampling of θ′ according to p_{θ(θ′)} and updates the average of θ′ using the sampled θ′ (step S705).

Further, the learning device 10 updates the variance-covariance matrix using θ′(step S706).

In a case where l is equal to or less than L (step S707, Yes), the learning device 10 returns to step S701 and repeats the processing.

On the other hand, in a case where l is not equal to or less than L (step S707, No), the learning device 10 calculates an inverse matrix of a unit matrix and a matrix including the estimated (updated) variance covariance (step S708). Then, the learning device 10 updates the model parameters using the calculated inverse matrix (step S709).

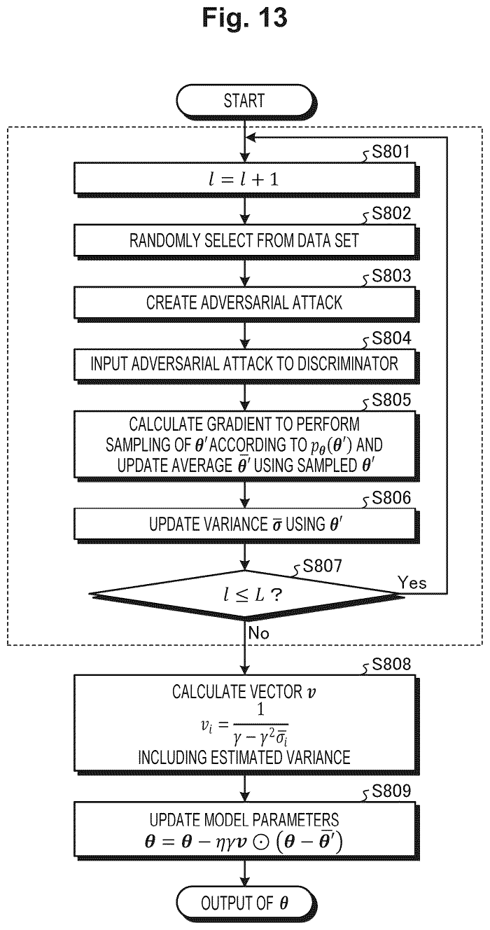

FIG. 13 is a flowchart illustrating a flow of update processing in adversarial learning according to an embodiment. As illustrated in FIG. 13, first, the learning device 10 increases l by 1 (step S801). Then, the learning device 10 randomly selects an input from the data set (step 3802).

Here, the learning device 10 creates an adversarial attack from the selected input (step 3803). Then, the learning device 10 inputs (applies) the created adversarial attack to the discriminator (step S804).

Here, the learning device 10 calculates the gradient to perform sampling of θ′ according to p_{θ(θ′)} and updates the average of θ′ using the sampled θ′ (step S805).

Further, the learning device 10 updates the variance using θ′(step S806).

In a case where l is equal to or less than L (step S807, Yes), the learning device 10 returns to step S801 and repeats the processing.

On the other hand, in a case where l is not equal to or less than L (step S807, No), the learning device 10 calculates a unit matrix and a vector including the estimated (updated) variance (step S808). Then, the learning device 10 updates the model parameters using the calculated vector (step S809).

### Effects of First Embodiment

As described above, the calculation unit 131 calculates an objective function when data created as an adversarial attack is input to the deep learning model by Entropy-SGD. The update unit 132 updates parameters of the deep learning model so that an objective function is optimized. As a result, the learning device 10 can improve the learning efficiency while smoothing the objective function of the adversarial learning.

The calculation unit 131 calculates a first matrix that is a variance-covariance matrix of parameters according to a probability distribution used in Entropy-SGD by stochastic gradient Langevin dynamics (SGLD). The update unit 132 updates the parameters of the deep learning model using the first matrix. As a result, the learning device 10 can improve the learning efficiency of the adversarial learning.

The calculation unit 131 calculates a first matrix in which a covariance of a variance-covariance matrix calculated by stochastic gradient Langevin dynamics (SGLD) of parameters according to a probability distribution used in Entropy-SGD is assumed to be 0. The update unit 132 updates the parameters of the deep learning model using the first matrix. As a result, the learning device 10 can further improve the learning efficiency of the adversarial learning.

The update unit 132 updates the parameters of the deep learning model by multiplying the inverse matrix of the first matrix that is the Hessian matrix by the gradient. As a result, the learning device 10 can smooth the gradient.

### System Configuration and Others

Each constituent of each illustrated device is functionally conceptual, and does not necessarily need to be physically configured as illustrated. That is, a specific form of distribution and integration of devices is not limited to the illustrated form, and all or some thereof may be functionally or physically distributed or integrated in any unit according to various loads, usage conditions, and the like. The whole or any part of each processing function performed in each device may be realized by a central processing unit (CPU) and a program analyzed and executed by the CPU, or may be realized as hardware by wired logic.

Among the respective processes described in the present embodiment, all or some of the processes described as being automatically performed may be manually performed, or all or some of the processes described as being manually performed may be automatically performed according to a known method. The processing procedure, the control procedure, the specific name, and the information including various types of data and parameters that are illustrated in the literatures and the drawings can be freely changed unless otherwise specified.

### Program

As an embodiment, the learning device 10 can be implemented by installing a program for executing the above learning processing as packaged software or online software in a desired computer. For example, an information processing device can be caused to function as the learning device 10 by causing the information processing device to execute the above program. The information processing device mentioned here includes a desktop or a laptop personal computer. The information processing device also includes a mobile communication terminal such as a smartphone, a mobile phone, and a personal handyphone system (PHS), a slate terminal such as a personal digital assistant (PDA), and the like.

In a case where a terminal device to be used by a user may be implemented as a client, the learning device 10 may also be implemented as a server device that provides a service related to the above-described processing to the client. For example, the server device is implemented as a server device that provides a service having a data set as an input and a learned deep learning model as an output. In this case, the server device may be implemented as a web server or may be implemented as a cloud that provides a service regarding the above processing by outsourcing.

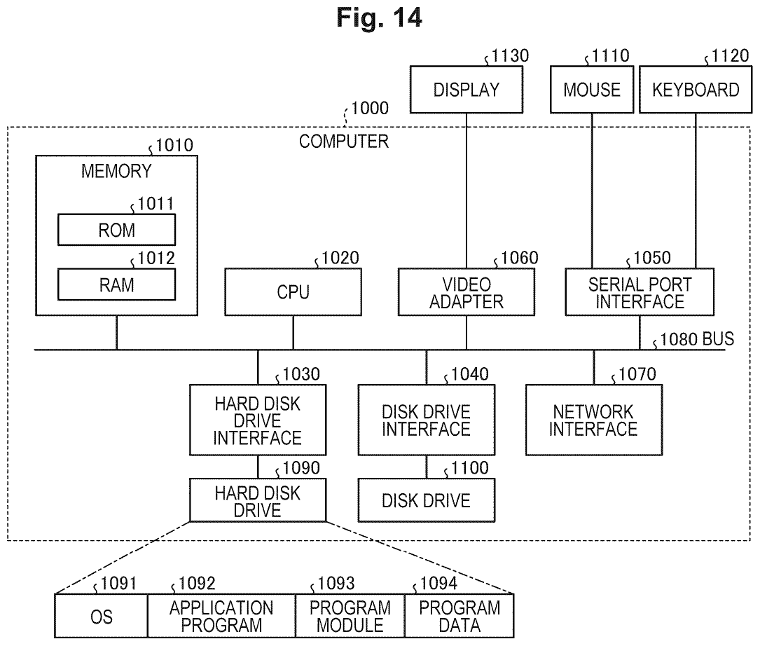

FIG. 14 is a diagram illustrating an example of a computer that executes the program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected with a disk drive 1100. For example, a removable storage medium such as a magnetic disk or an optical disc is inserted into the disk drive 1100. The serial port interface 1050 is connected with, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. That is, the program that defines each processing of the learning device 10 is implemented as the program module 1093 in which codes executable by a computer are described. The program module 1093 is stored in, for example, the hard disk drive 1090. For example, the program module 1093 for executing processing similar to the functional configuration in the learning device 10 is stored in the hard disk drive 1090. Note that the hard disk drive 1090 may be replaced with a solid state drive (SSD).

Setting data used in the processing of the above-described embodiment is stored, for example, in the memory 1010 or the hard disk drive 1090 as the program data 1094. The CPU 1020 reads the program module 1093 and the program data 1094 stored in the memory 1010 and the hard disk drive 1090 to the RAM 1012 as necessary, and executes the processing of the above-described embodiment.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

### REFERENCE SIGNS LIST

10 Learning device
11 Interface unit
12 Storage unit
13 Control unit
121 Model information
131 Calculation unit
132 Update unit

1. A learning device, comprising:
calculation circuitry that calculates by Entropy-SGD an objective function when data created as an adversarial attack is input to a deep learning model; and
update circuitry that updates parameters of the deep learning model so that the objective function is optimized.

2. The learning device according to claim 1, wherein:
the calculation circuitry calculates a first matrix that is a variance-covariance matrix of parameters according to a probability distribution used in Entropy-SGD by stochastic gradient Langevin dynamics (SGLD), and
the update circuitry updates the parameters of the deep learning model using the first matrix.

3. The learning device according to claim 1, wherein:
the calculation circuitry calculates a first matrix in which a covariance of a variance-covariance matrix calculated by stochastic gradient Langevin dynamics (SGLD) of parameters according to a probability distribution used in Entropy-SGD is assumed to be 0, and
the update circuitry updates the parameters of the deep learning model using the first matrix.

4. The learning device according to claim 2, wherein:
the update circuitry updates the parameters of the deep learning model by multiplying an inverse matrix of the first matrix that is a Hessian matrix by a gradient.

5. A learning method, comprising:
a calculation step of calculating by Entropy-SGD an objective function when data created as an adversarial attack is input to a deep learning model; and
an update step of updating parameters of the deep learning model so that the objective function is optimized.

6. A non-transitory computer readable medium including a learning program for causing a computer to function as the learning device according to claim 1.

7. A non-transitory computer readable medium including computer instructions, which when executed cause the method of claim 5 to be performed.
